(19) United States
(12) Patent Application Publication
(10) Pub. No.: US 2016/0368065 A1
(43) Pub. Date: Dec. 22, 2016

(54) Valve Hole and Machining Method Thereof

(71) Applicant: CITIC Dicastal CO., LTD, Qinhuangdao (CN)

(72) Inventors: Huiying Liu, Qinhuangdao (CN); Xiaoguang Huang, Qinhuangdao (CN); Jiandong Guo, Qinhuangdao (CN); Yun Han, Qinhuangdao (CN); Yuexin Lu, Qinhuangdao (CN); Zhiyuan Yu, Qinhuangdao (CN); Minghua Liu, Qinhuangdao (CN); Yongning Wang, Qinhuangdao (CN); Zhihua Zhu, Qinhuangdao (CN); Changhai Li, Qinhuangdao (CN)

(73) Assignee: CITIC Dicastal CO., LTD, Qinhuangdao (CN)

(21) Appl. No.: 15/183,023

(22) Filed: Jun. 15, 2016

(30) Foreign Application Priority Data
Jun. 16, 2015 (CN) 201510331029.2

(51) Int. Cl. B23B 35/00; B60C 29/02; F16K 27/00

(52) U.S. Cl. CPC B23B 35/005; F16K 27/00; B60C 29/02; B23B 2215/08; B23B 2222/04; B60B 2310/234; B60B 2310/228; B60B 2360/104

(57) ABSTRACT

The present invention provides a machining method of a valve hole and the valve hole machined with the method, wherein the method includes the following steps: (1) performing drilling machining for a valve hole by adopting a valve hole drill bit to achieve a predetermined machining dimension; (2) performing fine machining by adopting a reamer to allow the diameter of the valve hole to reach a stable dimensional state and removing impurities and aluminum scraps on the surface of the valve hole, thereby meeting the requirement of final fine grinding extrusion machining for a blank; and (3) performing final precision machining by adopting a grinding extrusion tool. A technical solution of the present invention can improve the machining precision and strength for the valve hole, prevent the generation of hot cracks and improve the anti-fatigue strength of the valve hole by more than 20%.

### TECHNICAL FIELD

The present invention relates to the field of automobile parts, and in particular to an automobile wheel valve hole and a machining method thereof.

### BACKGROUND ART

An aluminum wheel valve hole is a crucial part in an automobile wheel, and its machining quality and machining precision have influences not only on the assembly of the valve hole but also on the safety performance. The diameter tolerances for wheel valve holes of different specifications are generally ±0.2 mm Since the tolerance is relatively large, the technology mostly adopted at present is one-step forming performed by a valve hole drill bit. Although the one-step forming performed by the valve hole drill bit is simple in technology and can meet the requirement on the diameter tolerance, the valve hole is larger in the fluctuation quantity of the diameter and lower in surface precision, and micro cracks tend to be generated, resulting in greater safety potential hazards. As the technology of the manufacturing industry evolves and improves, in order to meet the requirement of high-precision manufacturing and assembly, there is an urgent need of a new technology to improve the machining precision of the valve hole and eliminate the risks of crack and air leakage of the valve hole.

### SUMMARY OF THE INVENTION

Therefore, an object of the present invention is to develop a machining method for a valve hole to improve the machining precision of the valve hole, thereby eliminating the risks of crack and air leakage of the valve hole.

Based on the current situation, the present invention develops a combined machining technology for a valve hole, wherein a valve hole drill bit is adopted at first for machining to reach an initial state, a reamer is then used for high-precision machining to allow the diameter of the valve hole to approach a stable state, and finally, a grinding extrusion tool is used to realize high-precision machining

In order to achieve the object of the present invention as described above, the present invention provides a technical solution as follows:

In one aspect of the present invention, a machining method for a valve hole is provided, which comprises the following steps: (1) performing drilling machining for a valve hole by adopting a valve hole drill bit to achieve a predetermined machining dimension; (2) performing fine machining by adopting a reamer to allow the diameter of the valve hole to reach a stable dimensional state and removing impurities and aluminum scraps on the surface of the valve hole, thereby meeting the requirement of final fine grinding extrusion machining for a blank; and (3) performing final precision machining by adopting a grinding extrusion tool.

In one preferable aspect of the present invention, in the step (1), a rotation speed of the valve hole drill bit is 1000 to 1200 r/min; a feed rate is 0.10 to 0.20 mm/r; and the predetermined machining dimension results from subtracting 0.12 to 0.18 mm from the median value of diameter of the valve hole.

In one preferable aspect of the present invention, the predetermined machining dimension results from subtracting 0.15 mm from the median value of diameter of the valve hole.

In one preferable aspect of the present invention, the feed rate is 0.12 mm/r.

In one preferable aspect of the present invention, in the step (2), a precision range for the fine machining by the reamer results from adding 0.01 mm to or subtracting 0.01 mm from a median value of the valve hole; a rotation speed of the reamer is 1800 to 2000 r/min; and a feed rate is 0.15 to 0.20 mm/r.

In one preferable aspect of the present invention, the rotation speed of the reamer is 1900 r/min

In one preferable aspect of the present invention, the feed rate is 0.18 mm/r.

In one preferable aspect of the present invention, in the step (3), a rotation speed of the grinding extrusion tool is 800 to 1000 min/r; a feed rate is 0.08 to 0.12 mm/r; an amount of machining is 0.03 to 0.10 mm; and preferably, the amount of machining is 0.04 mm

In one preferable aspect of the present invention, the feed rate is 0.10 mm/r.

In another aspect of the present invention, a valve hole prepared with the method according to any one as described above is provided.

In other aspects of the present invention, a valve hole and a machining method thereof, and in particular a technological method for combined forming through drilling, reaming and grinding, are provided, and the technological method can improve the surface precision, strength and anti-fatigue performance of the valve hole and reduce the risk of air leakage of the valve hole. The method comprises the following main steps: performing drilling machining for a valve hole by adopting a valve hole drill bit at first to achieve a predetermined machining dimension; then performing fine machining by adopting a reamer to allow the diameter of the valve hole to reach a stable dimensional state and removing impurities and aluminum scraps on the surface of the valve hole, thereby meeting the requirement of final fine grinding extrusion machining for a blank; and finally, performing final precision machining by adopting a grinding extrusion tool. By means of selecting a reasonable allowance technology, a rotation speed of the grinding extrusion tool, a feed rate and an amount of machining, the machining precision and strength of the valve hole can be improved, and hot cracks can be prevented.

A technical solution of the present invention brings the following beneficial technical effects:
in terms of the machining performed by a traditional valve hole drill bit, the variation range of the diameter of the valve hole is generally 0.10 mm; however, the final extrusion grinding in the technology provided by the present invention leads to micro plastic extrusion deformation on the surface of the valve hole, without chips; the dimensional precision range can be up to ±0.005 mm; and moreover, a residual compression stress is produced on a machined surface, which can improve the anti-fatigue strength of the valve hole by more than 20%.

### DETAILED DESCRIPTION OF THE INVENTION

### Embodiment 1

### Machining of Valve Holes

120 wheels subjected to surface machining by an aluminum alloy low-pressure casting production line of CiTiC Dicastal Co., Ltd. are sampled and divided into four groups, and are respectively subjected to valve hole machining according to the following methods:

### Test Group 1:

The diameter of a valve hole is 011.5±0.2 mm At first, a valve hole drill bit is adopted to perform drilling machining for a valve hole to achieve a predetermined machining dimension, with a rotation speed of the valve hole drill bit being 1200 r/min, a feed rate being 0.10 mm/r, and the predetermined dimension of the diameter of the valve hole being Φ11.35 mm; then, a reamer is adopted to perform fine machining to allow the diameter of the valve hole to reach a stable dimensional state and remove impurities and aluminum scraps on the surface of the valve hole, thereby meeting the requirement of final fine grinding extrusion machining for a blank, with a required dimensional precision range being Φ11.5±0.01 mm, a rotation speed of the reamer being 1800 r/min, and a feed rate being 0.15 mm/r; and finally, a grinding extrusion tool is adopted to perform final precision machining, with a rotation speed of the grinding extrusion tool being 1000 r/min, a feed rate being 0.08 mm/r and an amount of machining being 0.04 mm

### Test Group 2:

The diameter of a valve hole is Φ9.85±0.2 mm At first, a valve hole drill bit is adopted to perform drilling machining for a valve hole to achieve a predetermined machining dimension, with a rotation speed of the valve hole drill bit being 1000 r/min, a feed rate being 0.12 mm/r, and the predetermined dimension of the diameter of the valve hole being Φ9.7 mm; then, a reamer is adopted to perform fine machining to allow the diameter of the valve hole to reach a stable dimensional state and remove impurities and aluminum scraps on the surface of the valve hole, thereby meeting the requirement of final fine grinding extrusion machining for a blank, with a required dimensional precision range being Φ9.85±0.01 mm, a rotation speed of the reamer being 1900 r/min, and a feed rate being 0.18 mm/r; and finally, a grinding extrusion tool is adopted to perform final precision machining, with a rotation speed of the grinding extrusion tool being 800 r/min, a feed rate being 0.10 mm/r and a machining amount being 0.03 mm

### Control Group 1:

A traditional valve hole machining manner is used to perform valve hole machining, with machining conditions as follows: the diameter of the valve hole being Φ11.5±0.2 mm, a rotation speed of the valve hole drill bit being 1200 r/min, and a feed rate being 0.20 mm/r.

### Control Group 2:

A traditional valve hole machining manner is used to perform valve hole machining, with machining conditions as follows: the diameter of the valve hole being Φ9.85±0.2 mm, a rotation speed of the valve hole drill bit being 1200 r/min, and a feed rate being 0.20 mm/r.

### Embodiment 2

### Measurement on Machining Precision of Valve Holes in Each Group

A three-coordinate measurement method is used to measure the wheel valve holes from the above groups, with the results as shown in Table 1.

TABLE 1
Machining precision of wheel valve holes in each group

| | Mean diameter of | Standard deviation on |
|---|---|---|
| Group No. | valve holes (mm) | diameter of valve holes |
| Test Group 1 | Φ11.535 | 0.007 |
| Control Group 1 | Φ11.581 | 0.036 |
| Test Group 2 | Φ9.885 | 0.005 |
| Control Group 2 | Φ9.920 | 0.025 |

Results show that the valve holes prepared according to the method provided by the present invention have higher machining accuracy and precision, and the valve holes in the test groups have the diameters closer to a theoretical median vale, with smaller standard deviation and higher dimensional stability.

Based on the anti-fatigue strength tests on the valve holes from Test Groups 1 and 2 as well as Control Groups 1 and 2, results show that compared with the corresponding control groups, the test groups are improved by more than 20% in terms of anti-fatigue strength.

1. A machining method for a valve hole, comprising:
(1) performing drilling machining for a valve hole by adopting a valve hole drill bit to achieve a predetermined machining dimension;
(2) performing fine machining by adopting a reamer to allow the diameter of the valve hole to reach a stable dimensional state and removing impurities and aluminum scraps on the surface of the valve hole, thereby meeting the requirement of final fine grinding extrusion machining for a blank; and
(3) performing final precision machining by adopting a grinding extrusion tool.

2. The method according to claim 1, wherein in step (1), a rotation speed of the valve hole drill bit is 1000 to 1200 r/min; a feed rate is 0.10 to 0.20 mm/r; and the predetermined machining dimension results from subtracting 0.12 to 0.18 mm from the median value of diameter of the valve hole.

3. The method according to claim 2, wherein the predetermined machining dimension results from subtracting 0.15 mm from the median value of diameter of the valve hole.

4. The method according to claim 2, wherein the feed rate is 0.12 mm/r.

5. The method according to claim 1, wherein in the step (2), a precision range for the fine machining by the reamer results from adding 0.01 mm to or subtracting 0 01 mm from a median value of the valve hole; a rotation speed of the reamer is 1800 to 2000 r/min; and a feed rate is 0.15-0.20 mm/r.

6. The method according to claim 5, wherein the rotation speed of the reamer is 1900 r/min.

7. The method according to claim 5, wherein the feed rate is 0.18 mm/r.

8. The method according to claim 1, wherein in the step (3), a rotation speed of the grinding extrusion tool is 800 to 1000 r/min; a feed rate is 0.08 to 0.12 mm/r; and an amount of machining is 0.03 to 0.10 mm; and preferably, the amount of machining is 0.04 mm.

9. The method according to claim 8, wherein the feed rate is 0.10 mm/r.

10. A valve hole prepared with the method according to claim 1.
